(19) United States
(12) Patent Application Publication
(10) Pub. No.: US 2025/0224521 A1
(43) Pub. Date: Jul. 10, 2025

(54) FAST ACQUISITION IN CHALLENGING ENVIRONMENT

(71) Applicant: QUALCOMM Incorporated, San Diego, CA (US)

(72) Inventor: Qutubuddin MOHAMMED, Santa Clara, CA (US)

(21) Appl. No.: 18/408,393

(22) Filed: Jan. 9, 2024

(51) Int. Cl. G01S 19/24

(52) U.S. Cl. CPC G01S 19/24

(57) ABSTRACT

Aspects presented herein may enable a UE to achieve a faster acquisition of its estimated location in an environment with limited satellite access or satellite visibilities. In one aspect, a UE detects that the UE is operating in a specified global navigation satellite system (GNSS) environment. The UE verifies, in response to the detection that the UE is operating in the specified GNSS environment, that a duration between a prior GNSS positioning session and a current GNSS positioning session is less than a time threshold. The UE estimates, based on the duration is less than the time threshold, a current position of the UE based on prior position fix information from the prior GNSS session.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, an apparatus is provided for wireless communication at a user equipment (UE). The apparatus includes at least one memory and at least one processor coupled the at least one memory. The at least one processor, individually or in any combination, is configured to detect that a UE is operating in a specified global navigation satellite system (GNSS) environment. The at least one processor, individually or in any combination, is further configured to verify, in response to the detection that the UE is operating in the specified GNSS environment, that a duration between a prior GNSS positioning session and a current GNSS positioning session is less than a time threshold. The at least one processor, individually or in any combination, is further configured to estimate, based on the duration is less than the time threshold, a current position of the UE based on prior position fix information from the prior GNSS session.

In another aspect of the present disclosure, a method of wireless communication at a UE is provided. The method includes detecting that the UE is operating in a specified GNSS environment. The method further includes verifying, in response to the detection that the UE is operating in the specified GNSS environment, that a duration between a prior GNSS positioning session and a current GNSS positioning session is less than a time threshold. The method further includes estimating, based on the duration is less than the time threshold, a current position of the UE based on prior position fix information from the prior GNSS session.

In another aspect of the present disclosure, a computer-readable medium storing computer executable code is provided. The code when executed by at least one processor causes the at least one processor to detect that a UE is operating in a specified GNSS environment. The code when executed by the at least one processor further causes the at least one processor to verify, in response to the detection that the UE is operating in the specified GNSS environment, that a duration between a prior GNSS positioning session and a current GNSS positioning session is less than a time threshold. The code when executed by the at least one processor further causes the at least one processor to estimate, based on the duration is less than the time threshold, a current position of the UE based on prior position fix information from the prior GNSS session.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example of a GNSS challenged environment in accordance with various aspects of the present disclosure.

FIG. 7 is a diagram 700 illustrating an example of a GNSS solution implemented on a UE in accordance with various aspects of the present disclosure.

FIG. 8 is a diagram 800 illustrating an example of a fast acquisition in challenging environment (FACE) solution implemented on a UE in accordance with various aspects of the present disclosure.

FIG. 9 is a flowchart illustrating an example of the FACE algorithm in accordance with various aspects of the present disclosure.

FIG. 10 is a flowchart of a method of location estimation.

FIG. 11 is a flowchart of a method of location estimation.

FIG. 12 is a diagram illustrating an example of a hardware implementation for an example apparatus and/or network entity.

### DETAILED DESCRIPTION

Aspects presented herein may improve the accuracy and latency of global navigation satellite system (GNSS)-based positioning for a GNSS device (e.g., a user equipment (UE) with a GNSS-based positioning capability) when the GNSS device is under a GNSS challenged environment. Aspects presented herein are directed to techniques/solutions for GNSS for faster acquisition of estimated location in environment with low satellite access (e.g., canyons, mountains, trees). Aspects presented herein propose that if the duration between the last prior successful GNSS session is lower than a threshold (e.g., recent enough) then “fast acquisition” algorithm looks if prior/previous/last GNSS position fix details from prior session were preserved and if horizontal speed is below a threshold then acquire distance via the velocity of prior session and prior/previous/last GNSS position fix duration and use this information to compute new horizontal error position estimate (HEPE), estimate steering based on prior data, estimate new space vehicle (SV), compute position. Based on this information GNSS position is calculated. As such, aspects presented herein may have the advantages of providing faster acquisition of SVs and faster time to compute a position fix in a challenging GNSS environment with limited SV(s) visibility. This may improve user experience in the standalone and in situations for emergency location services in an environment surrounded by mountains and trees.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

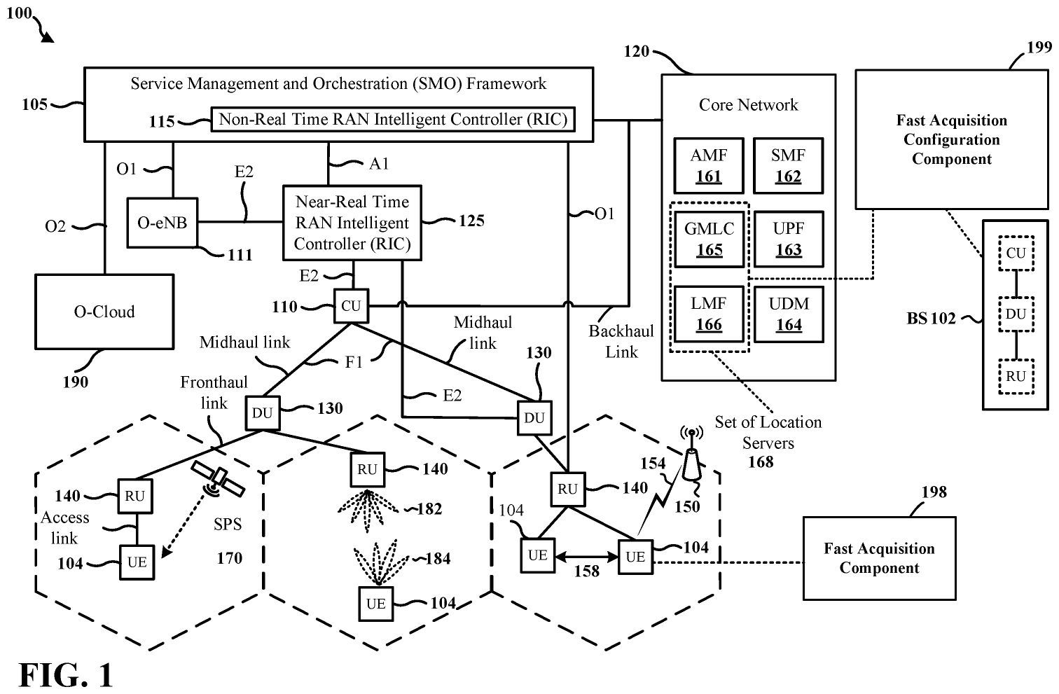

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a fast acquisition component 198 that may be configured to detect that the UE is operating in a specified global navigation satellite system (GNSS) environment; verify, in response to the detection that the UE is operating in the specified GNSS environment, that a duration between a prior GNSS positioning session and a current GNSS positioning session is less than a time threshold; and estimate, based on the duration is less than the time threshold, a current position of the UE based on prior position fix information from the prior GNSS session. In certain aspects, the base station 102 or the one or more location servers 168 may have a fast acquisition configuration component 199 that may be configured to provide configurations and/or parameters related to the fast acquisition in challenged environment (FACE) algorithm for the UE 104.

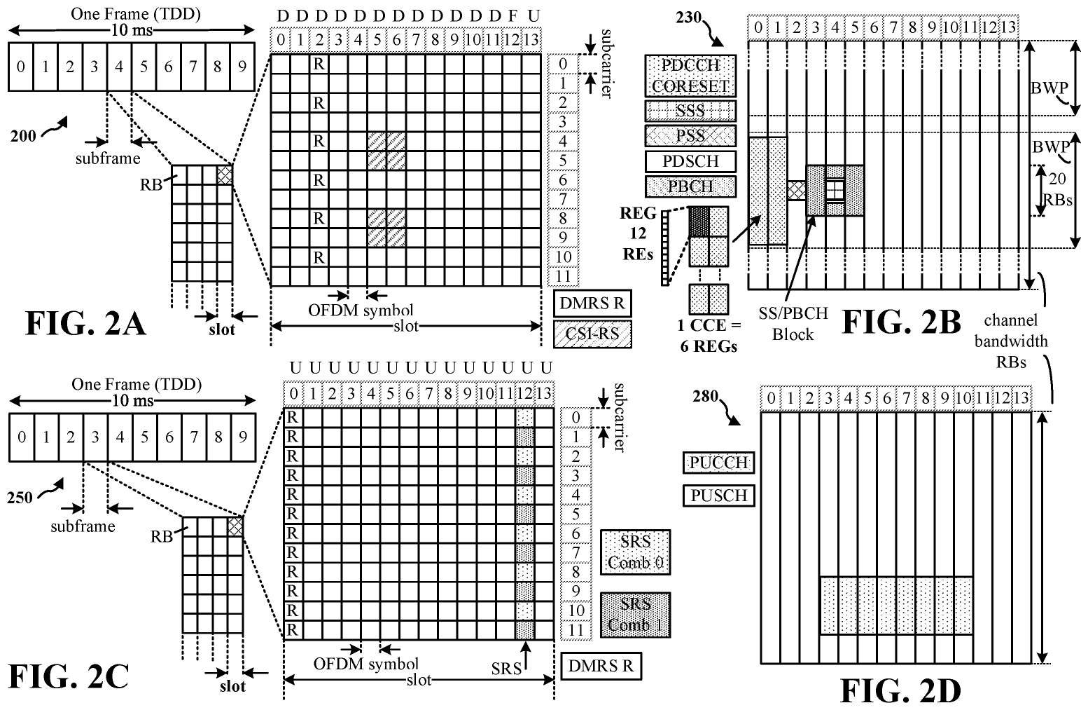

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

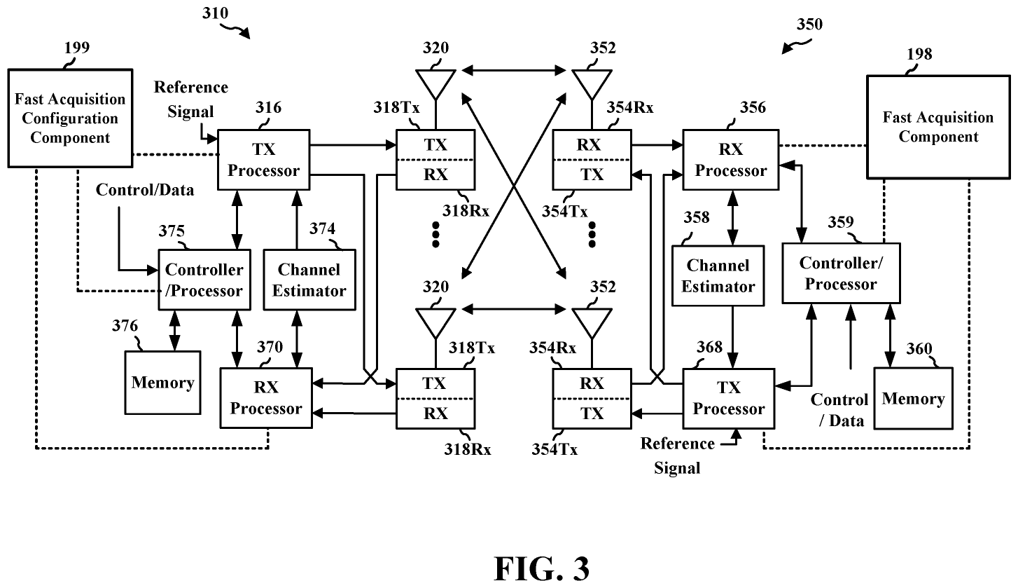

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the fast acquisition component 198 of FIG. 1.

At least one of the TX processor 316, the RX processor 370, and the controller/processor 375 may be configured to perform aspects in connection with the fast acquisition configuration component 199 of FIG. 1.

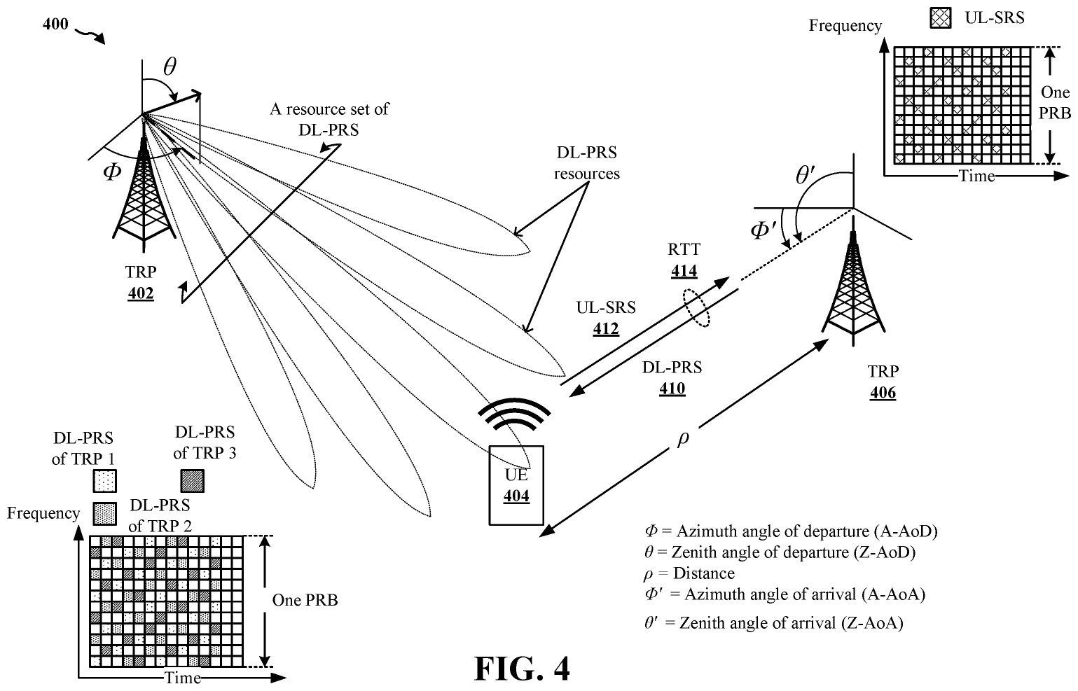

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|-|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FRI and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE, a mobile device, a navigation system, a positioning system, etc.) equipped with a global navigation satellite system (GNSS) receiver may determine its location based on reception of signals from multiple satellites, which may be referred to as “GNSS positioning,” “GNSS-based positioning” or “satellite-based positioning.” GNSS is a network of satellites broadcasting timing and orbital information used for navigation and positioning measurements. In addition, GNSS may refer to the International Multi-Constellation Satellite System, which may include global positioning system (GPS), global navigation satellite system (GLONASS), Beidou, Galileo, and any other constellation system. GNSS may include multiple groups of satellites (which may be referred to as GNSS satellites), known as constellations, that broadcast signals (which may be referred to as GNSS signals) to control stations and users of the GNSS. Based on the broadcast signals, the users may be able to determine their locations (e.g., via a trilateration process). For purposes of the present disclosure, a device (e.g., a UE) that is equipped with a GNSS receiver or is capable of receiving GNSS signals may be referred to as a GNSS device. In addition, a device that is capable of transmitting GNSS signals, such as a GNSS satellite, a GPS satellite, etc., may be referred to as a space/satellite vehicle (SV). As such, the term “satellite” may be used interchangeably with “space/satellite vehicle” and/or “SV” throughout the specification.

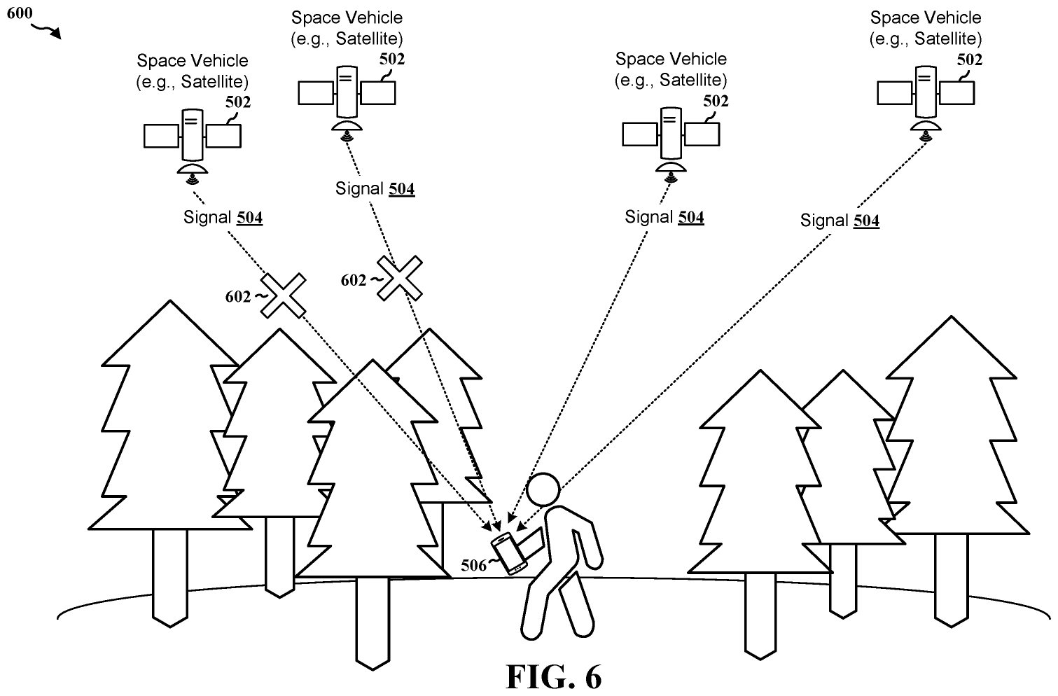

In some examples, a software or an application that accepts positioning related measurements from GNSS chipset(s), sensor(s), and/or camera(s) to estimate the position, the velocity, and/or the altitude of a device (or a target) may be referred to as a positioning engine (PE). Similarly, a positioning engine that is capable of achieving certain high level of accuracy (e.g., a centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK as described in connection with FIG. 6) may be considered as a PPE. Another example of PPE is a positioning engine that is capable of performing precise point positioning (PPP). PPP is a positioning technique that removes or models GNSS system errors to provide a high level of position accuracy from a single receiver.

In some examples, a navigation application/software may refer to an application/software in a user equipment (e.g., a smartphone, an in-vehicle navigation system, a GPS device, etc.) that is capable of providing navigational directions in real time. Over the last few years, users have increasingly relied on navigation applications because they have provided various benefits. For example, navigation applications may provide convenience to users as they enable users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection and a GPS/GNSS navigation system to provide turn-by-turn guided instructions on how to arrive at a given destination.

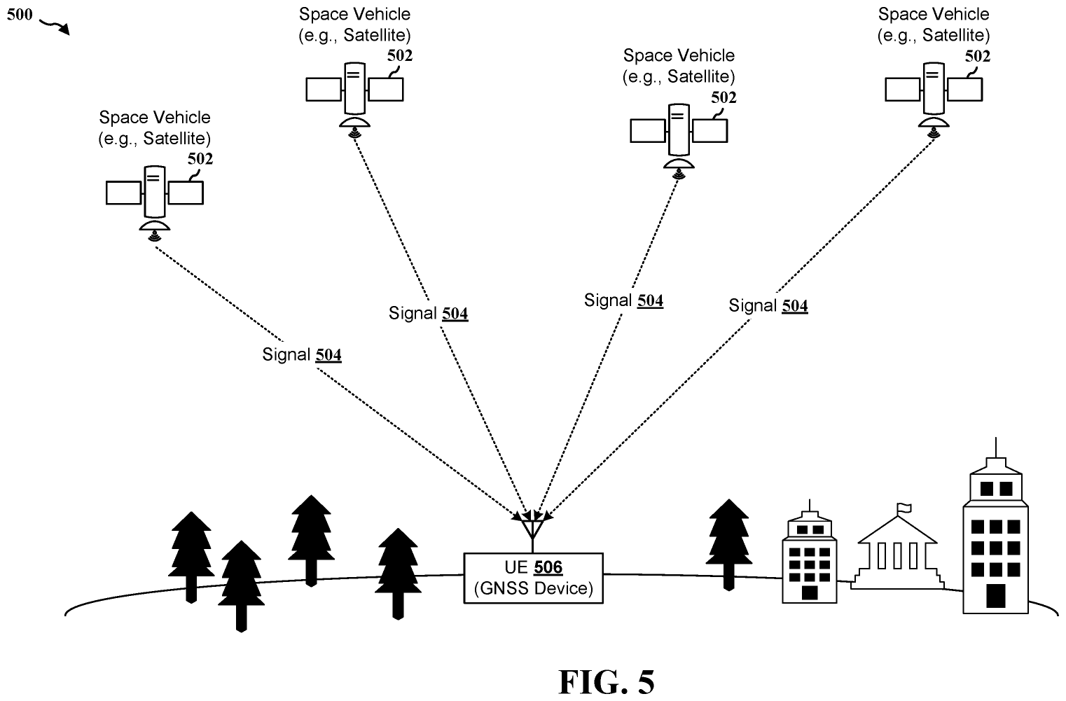

FIG. 5 is a diagram 500 illustrating an example of GNSS-based positioning in accordance with various aspects of the present disclosure. A UE 506 (e.g., a GNSS device) may calculate its position and time based at least in part on data (e.g., GNSS signals 504) received from multiple space vehicles (SVs) 502 (e.g., multiple GNSS satellites), where each SV 502 may carry a record of its position and time and may transmit that information (e.g., the record) to the UE 506. Each SV 502 may further include a clock that is synchronized with other clocks of SVs and with ground clock(s). If an SV 502 detects that there is a drift from the time maintained on the ground, the SV 502 may correct it. The UE 506 may also include a clock, but the clock for the UE 506 may be less stable and precise compared to the clock for each SV 502.

As the speed of radio waves may be constant and independent of the satellite speed, a time delay between a time the SV 502 transmits a GNSS signal 504 and a time the UE 506 receives the GNSS signal 504 may be proportional to the distance from the SV 502 to the UE 506. In some examples, a minimum of four SVs may be specified by the UE 506 for computing/calculating one or more unknown quantities associated with positioning (e.g., three position coordinates and clock deviation from satellite time, etc.). In other words, in some implementations, for a UE to perform the GNSS-based positioning, the UE may be specified to receive signals from at least four SVs.

Each SV 502 may broadcast the GNSS signal 504 (e.g., a carrier wave with modulation) continuously that may include a pseudorandom code (e.g., a sequence of ones and zeros) which may be known to the UE 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the UE 506 may measure the time of arrivals (TOAs) of the GNSS signals 504 and calculate the time of flights (TOFs) for the GNSS signals 504. Then, based on the TOFs, the UE 506 may compute its three-dimensional position and clock deviation, and the UE 506 may determine its position on the Earth. For example, the UE 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

FIG. 6 is a diagram 600 illustrating an example of a GNSS challenged environment in accordance with various aspects of the present disclosure. In some scenarios, when a GNSS device is performing a GNSS navigation activity (e.g., during a GNSS-based positioning session) in a GNSS challenged environment, where there is a limited SV visibility and there are no initial position estimate and no external position injection (EPI) or external course position injection (e.g., from an application processor (AP)), the time it takes for the GNSS device to (millisecond) decode at least a minimum of four GNSS SVs may be significant and cause delay to compute the position of the GNSS device. For purposes of the present disclosure, a GNSS challenged environment or a limited SV visibility, at a high level, may refer to an environment or a condition where a GNSS device is unable to receive/decode GNSS signals from at least four satellites and/or unable to receive/decode GNSS signals with signal strength above a threshold from at least four satellites, such that the GNSS device may not be able to perform GNSS-based positioning effectively and/or accurately.

For example, as shown at 602, the UE 506 (e.g., a mobile phone) may be under a GNSS challenged environment where the UE 506 is surrounded by mountains and trees and the UE 506 is just able to receive GNSS signals from two SVs (e.g., the UE 506 has a limited SV visibility). When there are no initial position estimate and no EPI by an AP (e.g., in some scenarios, an AP may provide an estimated/coarse location of the UE 506 to the UE 506 to assist the UE 506 in calculating its position), then the time for the UE 506 to decode at least a minimum of four GNSS SVs (e.g., for computing a position fix) may be long, and may cause a delay in computing/estimating the position of the UE 506. Such delay may cause degradation in the performance of the UE 506 and impact the user experience in both emergency location services and standalone navigation. For example, in typical GNSS positioning designs, when there are no initial position estimate or EPI, a GNSS device may not be able to obtain/estimate the horizontal error position estimate (HEPE) and/or the elevation/azimuth of SV(s) and compute a position fix until the time millisecond for a minimum of four SVs is known (which may be referred to as the “millisecond decode”). As such, it may take a significant time for the GNSS device to computer its first position fix. For purposes of the present disclosure, a position fix may refer to determining and establishing a precise location (e.g., with the precision reaching a precision threshold) of an object on the Earth's surface at a particular point in time.

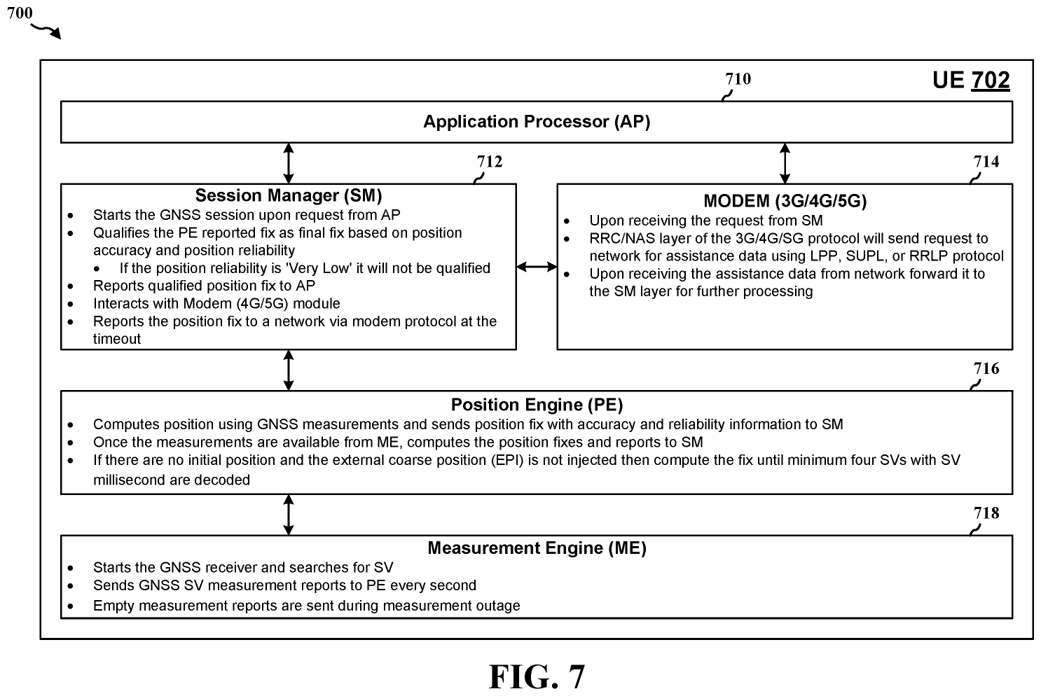

FIG. 7 is a diagram 700 illustrating an example of a GNSS solution implemented on a UE in accordance with various aspects of the present disclosure. In one example, a UE 702 (e.g., a GNSS device) may be configured to perform GNSS-based positioning with following components/modules/functions: (1) an application processor (AP) as shown at 710, (2) a session manager (SM) as shown at 712, (3) a modem as shown at 714, a positioning engine (PE) as shown at 716, and a measurement engine (ME) as shown at 718.

As shown at 712, the SM may be responsible for: (1) starting a GNSS-based positioning session upon a request from the AP (e.g., an navigation application sending a request to initiate a GNSS-based positioning session), (2) qualifying the PE reported fix as a final fix based on position accuracy and position reliability (e.g., if the position accuracy and/or reliability are below a defined threshold, the fix may not be qualified), (3) reporting qualified position fix to the AP, (4) interacting with the modem (4G/5G), and/or reporting the position fix to a network via a modem protocol (e.g., at the timeout).

As shown at 714, upon receiving a request from the SM, the modem may use the radio resource control (RRC)/non-access stratum (NAS) layer of a 3G/4G/SG protocol to send a request to the network for assistance data (AD), such as using the LTE positioning protocol (LPP), the secure user-plane location (SUPL) protocol, or the radio resource location services (LCS) protocol (RRLP), etc. Then, upon receiving the assistance data from the network, the modem may forward it to the SM layer for further processing.

As shown at 716, the PE may be responsible for computing the position of the UE 702 using GNSS measurements and sending the position fix with the accuracy and reliability information to the SM. For example, once the GNSS measurements are available from the ME, the PE may compute the position fixes and report them to the SM. If there are no initial position and the EPI is not injected (e.g., from the AP), then the PE may be configured to compute the fix until a minimum of four SVs with SV millisecond are decoded.

As shown at 718, the ME may be responsible for starting the GNSS receiver (of the UE 702) and searching for SVs. The ME may be configured to send GNSS SV measurement reports to the PE periodically (e.g., every second), and the ME may also be configured to send empty measurement reports during a measurement outage.

Aspects presented herein may improve the accuracy and latency of GNSS-based positioning for a GNSS device (e.g., a UE with a GNSS-based positioning capability) when the GNSS device is under a GNSS challenged environment. For purposes of the present disclosure, aspects presented herein may be referred as the “fast acquisition in challenging environment (FACE), where the “acquisition” may refer to obtaining/estimating the position or position information related to a wireless device.

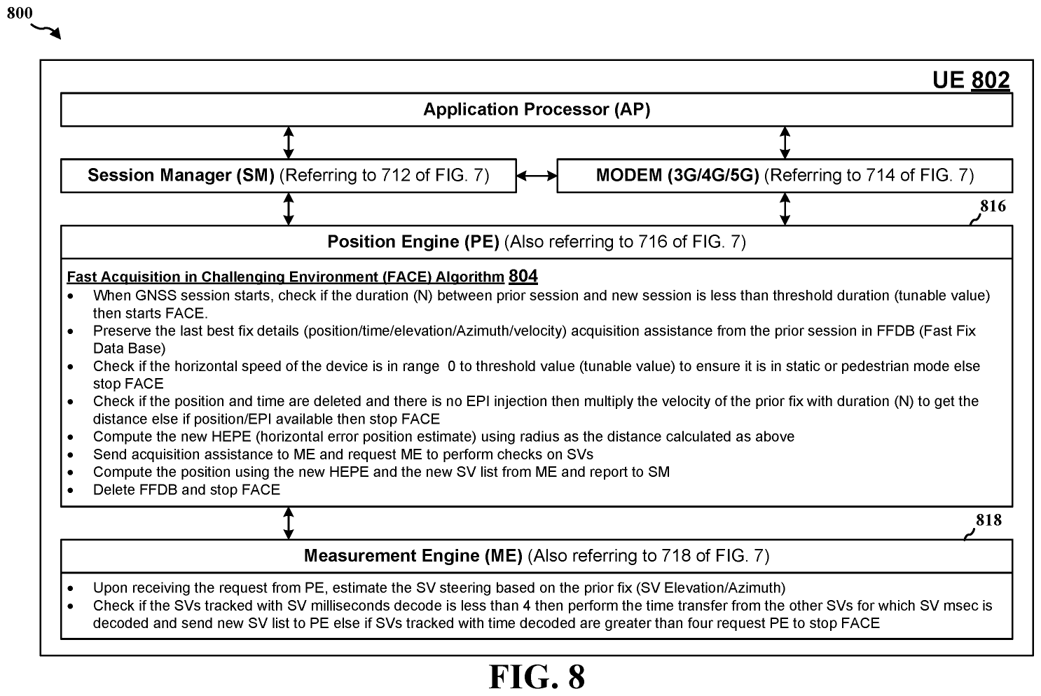

FIG. 8 is a diagram 800 illustrating an example of a FACE algorithm/solution implemented on a UE (e.g., in addition to the GNSS solution illustrated on FIG. 7) in accordance with various aspects of the present disclosure. In one aspect of the present disclosure, as shown at 816, when a GNSS-based positioning session starts, a UE 802 (e.g., a GNSS device) or the PE of the UE 802 may be configured to run a FACE algorithm 804 based on a set of conditions/criteria. For example, if the UE 802 detects that it is in a GNSS challenged environment, the UE 802 may first check/verify if the duration (N) between a prior GNSS-based positioning session and a new (e.g., a current) GNSS-based positioning session is less than a threshold duration (e.g., a configurable value such as 15 seconds, 30 seconds, 1 minute, etc.), and the UE 802 may start the FACE algorithm 804 if the duration (N) is less than the threshold duration (e.g., N<threshold duration).

After the FACE algorithm 804 is initiated, the UE 802 (or the PE of the UE 802) may be configured to preserve the last/previous (best or most suitable) position fix information/details from the prior GNSS-based positioning session (e.g., position information of the UE 802, time information in which the position is obtained, elevation and/or azimuth information of SV(s) associated with the prior GNSS-based positioning session, and/or velocity information of the UE 802, etc.). Fur purposes of the present disclosure, “preserve” may refer that the UE 802 stores the position fix information/details in a memory or a cache, and protects/prevents the position fix information/details from being deleted/cleared until certain condition(s) are met. For most PE configurations, a PE may be configured to delete/clear position fix information/details from prior positioning session(s) during the current positioning session. As such, by enabling the UE 802 to preserve the position fix information/details, the UE 802 may have the capability to access the preserved access position fix information/details in subsequent positioning session(s). In some examples, the UE 802 may obtain the last/previous position fix information/details from a database (e.g., a fast fix database (FFDB), a memory, a cache, etc.) using/via an acquisition assistance.

In some implementations, the UE 802 (or the PE of the UE 802) may also be configured to check/verify whether the horizontal speed (HSpeed) of the UE 802 is within a defined range, such between zero (0) and a threshold value (e.g., a configuration threshold value). Such configuration may ensure that the UE 802 is under a static mode or a slow-moving mode (e.g., a pedestrian mode) as the FACE algorithm 804 may not be able to work accurately if the UE 802 is moving at a high speed. If the UE 802 is not within the defined range, the UE 802 may be configured to terminate the FACE algorithm 804 (and proceed with just the GNSS solution discussed in connection with FIG. 7).

In some implementations, the UE 802 (or the PE of the UE 802) may also be configured to check/verify whether the position information and/or the time information are deleted (or are still available) (e.g., based on the last/previous position fix information/details from the prior GNSS-based positioning session), and/or whether there is any EPI injection (e.g., from the AP). If the position and time information are deleted and there is no EPI injection, then the UE 802 may be configured to multiply the velocity (obtained from the last/previous position fix) with the duration (N) to get an estimated distance (travelled by the UE 802). On the other hand, if the position/time information is available and/or if there is an EPI injection, the UE 802 may be configured to terminate the FACE algorithm 804 (and proceed with just the GNSS solution discussed in connection with FIG. 7).

After obtaining the estimated distance, the UE 802 (or the PE of the UE 802) may compute a HEPE (horizontal error position estimate) using radius as the estimated distance calculated as above. For illustration/differentiation purposes, this HEPE value may be referred to as a “new HEPE” value, which is obtained based on multiplying the velocity from a last/previous position fix with the duration (N) (e.g., the duration between last GNSS-based positioning session and the current GNSS-based positioning session).

In some implementations, the PE may also be configured to send an acquisition assistance to the ME and request the ME to perform checks on SVs (e.g., checking whether there are available SVs). As shown at 818, upon or after receiving the request from the PE, the ME may be configured to estimate the SV steering based on the prior/last position fix (e.g., based on the elevation and/or azimuth information). In addition, the ME may also be configured to check/verify whether the number of SVs tracked with SV milliseconds decode is less than four (e.g., the number of available satellites for receiving GNSS signals is less than four). If the number of SVs tracked with SV milliseconds decode is less than four, the ME may perform a time transfer that calculates/estimates the time/trajectories for a list of SVs based on the SV(s) with millisecond (ms) decoded, and the ME may send this list of SVs to the PE. However, if the number of SVs tracked with ms decoded are greater than four, the ME may request the PE (or the UE 802) to stop the FACE algorithm 804.

As shown at 816, after the PE obtains the list of SVs from the ME and also the SV steering information (if available), the PE may compute/estimate the position of the UE 802 using the new HEPE and the list of SVs (and SV steering information if available) from the ME. Then, the PE may report the computed/estimated position of the UE 802 to the SM. After reporting to the SM, the PE may be configured to delete the database (e.g., the FFDB) and stop the FACE algorithm 804.

After obtaining the computed/estimated position of the UE 802 from the PE, the SM may output an indication of the computed/estimated position of the UE 802, such as to the AP, stored it in a database, and/or transmitting it to a network entity (e.g., via the modem), etc.

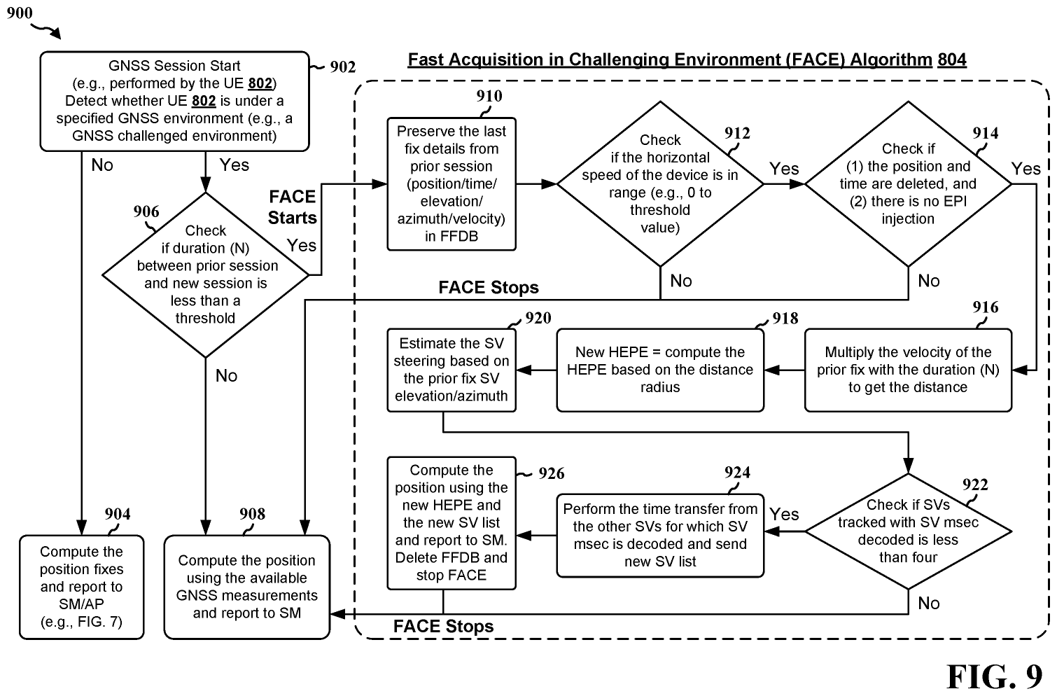

FIG. 9 is a flowchart 900 illustrating an example of the FACE algorithm in accordance with various aspects of the present disclosure. As shown at 902, the UE 802 (e.g., a GNSS device) or the position engine (PE) of the UE 802 may be configured to start a GNSS-based positioning session, such as in response to an application (e.g., a navigation application, a positioning application, etc.) requesting for the position of the UE 802 to be determined. After the GNSS-based positioning session starts or is initiated, the UE 802 may detect or verify whether UE 802 is in a defined/specified GNSS environment, such as within a GNSS challenged environment where there is a limited SV visibility (e.g., the UE 802 is unable to receive/decode GNSS signals and/or unable to receive/decode GNSS signals with signal strength above a threshold from at least four satellites).

As shown at 904, if the UE 802 detects that it is not in a defined/specified GNSS environment, the UE 802 (or the PE of the UE 802) may be configured to compute the position fixes of the UE 802 based on a typical GNSS solution as described in connection with FIGS. 5 and 7, and report the computed position fixes to the session manager (SM) and/or the application processor (AP).

On other hand, as shown at 906, if the UE 802 detects that it is in a defined/specified GNSS environment, the UE 802 (or the PE of the UE 802) may be configured to check/verify if the duration (N) between a prior GNSS-based positioning session and the current GNSS-based positioning session is less than a threshold duration (e.g., a configurable value such as 15 seconds, 30 seconds, 1 minute, etc.).

As shown at 908, if the duration (N) between the prior GNSS-based positioning session and the current GNSS-based positioning session is not less than the threshold duration (or exceeds the maximum threshold duration allowed), the UE 802 (or the PE of the UE 802) may be configured to compute the position of the UE 802 using available SVs and/or available GNSS measurements, and report the computed position to the SM.

As shown at 910, if the duration (N) between the prior GNSS-based positioning session and the current GNSS-based positioning session is less than the threshold duration (e.g., N<threshold duration), the UE 802 may be configured to start the FACE algorithm 804. After the FACE algorithm 804 starts, the UE 802 (or the PE of the UE 802) may be configured to preserve the last/previous (best or most suitable) position fix information/details from the prior GNSS-based positioning session, which may include the last/previous position information of the UE 802, the last/previous time information of the UE 802, the elevation/azimuth information of the SV(s) associated with the prior GNSS-based positioning session, and/or the last/previous velocity information of the UE 802, etc. In some examples, the UE 802 may obtain the last/previous position fix information/details from a database, such as from an FFDB using/via an acquisition assistance.

As shown at 912, in some implementations, the UE 802 (or the PE of the UE 802) may be configured to check/verify whether the horizontal speed (HSpeed) of the UE 802 is within a defined range, such between zero (0) (e.g., miles/kilometers per hour) and a threshold value (e.g., e.g., 5, 10 miles/kilometers per hour, etc.). Such configuration may ensure that the UE 802 is under a static mode or a slow-moving mode (e.g., a pedestrian mode). If the UE 802 is not within the defined range, the UE 802 may be configured to terminate the FACE algorithm 804, compute the position of the UE 802 using available SVs and/or available GNSS measurements, and report the computed position to the SM as shown at 908. If the UE 802 is within the defined range, the UE 802 may proceed to the next process/step (e.g., to 914).

As shown at 914, in some implementations, the UE 802 (or the PE of the UE 802) may be configured to check/verify (1) whether the position information and/or the time information are deleted (or are still available) (e.g., based on the last/previous position fix information/details from the prior GNSS-based positioning session), and/or (2) whether there is any EPI injection (e.g., from the AP). If the position/time information is available and/or if there is an EPI injection, the UE 802 may be configured to terminate the FACE algorithm 804, compute the position of the UE 802 using the position/time, the EPI, available SVs, and/or available GNSS measurements, and report the computed position to the SM as shown at 908. If the position and time information are deleted and there is no EPI injection, the UE 802 may proceed to the next process/step (e.g., to 916).

As shown at 916, based on there being no position/time information and EPI injection, then the UE 802 may be configured to multiply the velocity (obtained from the last/previous position fix) with the duration (N) to get an estimated distance travelled by the UE 802 (e.g., estimated distance=duration (N)*velocity).

As shown at 918, after obtaining the estimated distance, the UE 802 (or the PE of the UE 802) may compute a horizontal error position estimate (HEPE) (e.g., a new HEPE) based on the estimated distance calculated at 916 (e.g., using the estimated distance as the radius for computing the new HEPE).

As shown at 920, in some implementations, the PE of the UE 802 may also be configured to send an acquisition assistance to the ME of the UE 802 and request the ME to perform checks on SVs (e.g., checking whether there are available SVs). Upon or after receiving the request from the PE, the ME may be configured to estimate the SV steering based on the prior/last position fix (e.g., based on the elevation and/or azimuth information of SV(s) associated with the prior GNSS-based positioning session).

In addition, as shown at 922, the ME of the UE 802 may also be configured to check/verify whether the number of SVs tracked with SV milliseconds decode is less than four (e.g., the number of available satellites for receiving GNSS signals is less than four). If the number of SVs tracked with SV milliseconds decode is not less than four (e.g., is four or more than four), the UE 802 may be configured to terminate the FACE algorithm 804, compute the position of the UE 802 using available SVs and/or available GNSS measurements, and report the computed position to the SM as shown at 908. If the number of SVs tracked with SV milliseconds decode is less than four, the UE 802 (or the ME of the UE 802) may proceed to the next process/step (e.g., to 924).

As shown at 924, if the number of SVs tracked with SV milliseconds decode is less than four, the UE 802 (or the ME of the UE 802) may be configured to perform a time transfer that calculates/estimates the time/trajectories for a list of SVs based on the SV(s) with millisecond (ms) decoded (e.g., obtained at 922), and the ME may send this list of SVs to the PE.

As shown at 926, after the PE obtains the list of SVs from the ME and also the SV steering information (e.g., if available at 920), the UE 802 (or the PE of the UE 802) may compute/estimate the position of the UE 802 using the new HEPE (e.g., computed at 918), the list of SVs (e.g., obtained at 924), and/or the SV steering information (e.g., if available at 920). Then, the UE 802 (or the PE of the UE 802) may report the computed/estimated position of the UE 802 to the SM. After reporting to the SM, the UE 802 (or the PE of the UE 802) may be configured to delete the database (e.g., the FFDB) and stop the FACE algorithm 804. In addition, after the UE 802 stops the FACE algorithm 804, the UE 802 may continue to compute the position of the UE 802 using available SVs and/or available GNSS measurements, and report the computed position to the SM as shown at 908.

In some implementations, after obtaining the computed/estimated position of the UE 802, the UE 802 (or the SM of the UE 802) may output an indication of the computed/estimated position of the UE 802, such as to the AP, stored it in a database, and/or transmitting it to a network entity (e.g., via the modem), etc.

Aspects presented herein are directed to techniques/solutions for GNSS for faster acquisition of estimated location in environment with low satellite access (e.g., canyons, mountains, trees). Aspects presented herein propose that if the duration between the last prior successful GNSS session is lower than a threshold (e.g., recent enough) then “fast acquisition” algorithm looks if prior/previous/last GNSS position fix details from prior session were preserved and if horizontal speed is below a threshold then acquire distance via the velocity of prior session and prior/previous/last GNSS position fix duration and use this information to compute new HEPE, estimate steering based on prior data, estimate new SV, compute position. Based on this information GNSS position is calculated. As such, aspects presented herein may have the advantages of providing faster acquisition of SVs and faster time to compute a position fix in a challenging GNSS environment with limited SV(s) visibility. This may improve user experience in the standalone and in the critical situation for emergency location services in an environment surrounded by mountains and trees.

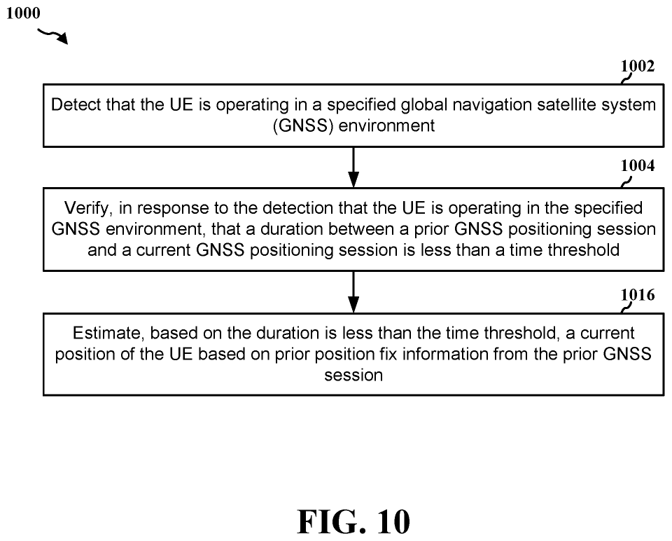

FIG. 10 is a flowchart 1000 of location estimation at a user equipment (UE). The method may be performed by a UE (e.g., the UE 104, 404, 506, 702, 802; the apparatus 1204). The method may enable the UE to achieve a faster acquisition of its estimated location in an environment with limited satellite access or SV visibilities (e.g., the UE is surrounded by canyons, mountains, trees, etc.).

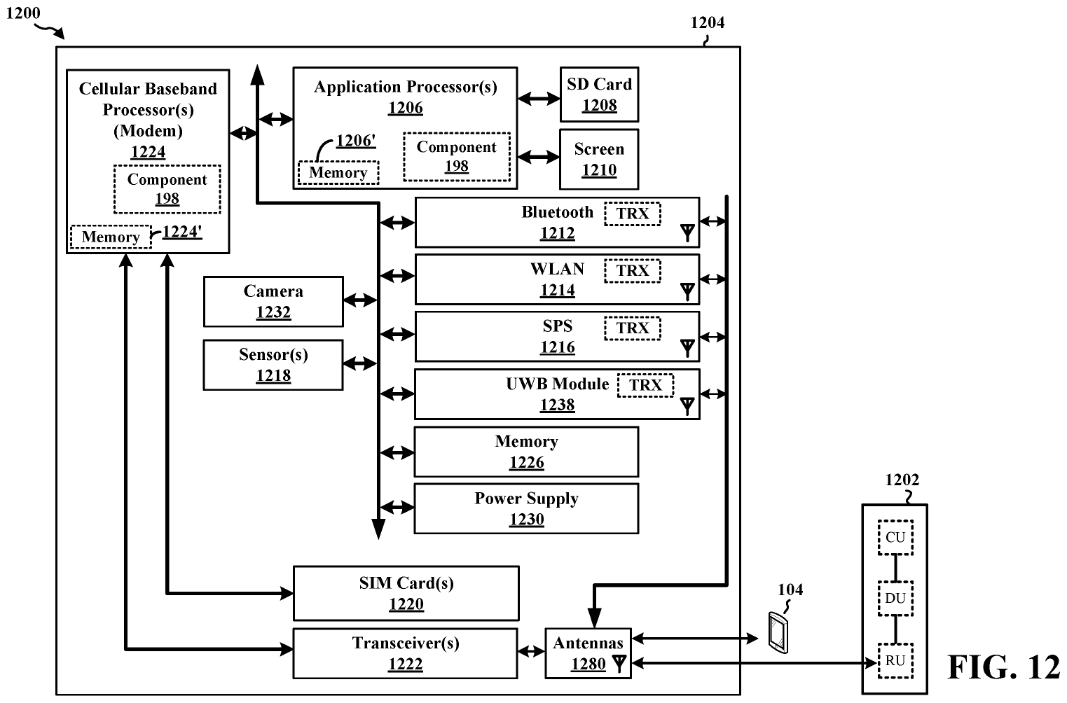

At 1002, the UE may detect that the UE is operating in a specified GNSS environment, such as described in connection with FIGS. 8 and 9. For example, as discussed in connection with 902 of FIG. 9, after the GNSS-based positioning session starts or is initiated, the UE 802 may detect or verify whether UE 802 is in a defined/specified GNSS environment, such as within a GNSS challenged environment where there is a limited SV visibility (e.g., the UE 802 is unable to receive/decode GNSS signals and/or unable to receive/decode GNSS signals with signal strength above a threshold from at least four satellites). The detection of the UE being operating in a specified GNSS environment may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, to detect that the UE is operating in the specified GNSS environment, the UE may be configured to detect at least one of: receptions of GNSS signals from a set of satellites being below a reception threshold, or a number of satellites available for GNSS-based positioning being less than four.

At 1004, the UE may verify, in response to the detection that the UE is operating in the specified GNSS environment, that a duration between a prior GNSS positioning session and a current GNSS positioning session is less than a time threshold, such as described in connection with FIGS. 8 and 9. For example, as discussed in connection with 906 of FIG. 9, if the UE 802 detects that it is in a defined/specified GNSS environment, the UE 802 (or the PE of the UE 802) may be configured to check if the duration (N) between a prior GNSS-based positioning session and the current GNSS-based positioning session is less than a threshold duration (e.g., a configurable value such as 15 seconds, 30 seconds, 1 minute, etc.). The verification of the duration may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, the UE may preserve, based on the duration is less than the time threshold, prior position fix information from the prior GNSS session, such as described in connection with FIGS. 8 and 9. For example, as discussed in connection with 910 of FIG. 9, if the duration (N) between the prior GNSS-based positioning session and the current GNSS-based positioning session is less than the threshold duration (e.g., N<threshold duration), the UE 802 may be configured to start the FACE algorithm 804. After the FACE algorithm 804 starts, the UE 802 (or the PE of the UE 802) may be configured to preserve the last/previous (best or most suitable) position fix information/details from the prior GNSS-based positioning session. The preservation of the prior position fix information from the prior GNSS session may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, the prior position fix information may include at least one of: a previous location of the UE, a previous velocity of the UE, a time in which the prior position fix information is obtained, elevation of a set of satellites associated with the prior GNSS positioning session, or azimuth of the set of satellites associated with the prior GNSS positioning session.

At 1016, the UE may estimate, based on the duration is less than the time threshold, a current position of the UE based on prior position fix information from the prior GNSS session, such as described in connection with FIGS. 8 and 9. For example, as discussed in connection with 926 of FIG. 9, after the PE obtains the list of SVs from the ME and also the SV steering information (e.g., if available at 920), the UE 802 (or the PE of the UE 802) may compute/estimate the position of the UE 802 using the new HEPE (e.g., computed at 918), the list of SVs (e.g., obtained at 924), and/or the SV steering information (e.g., if available at 920). The estimation of the current position of the UE may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, to estimate the current position of the UE based on the prior position fix information, the UE may be configured to multiply a previous velocity of the UE with the duration to obtain an estimated distance, where the previous velocity of the UE is from the prior position fix information, compute a HEPE based on the estimated distance, and compute the current position of the UE based on the computed HEPE.

In another example, the UE may identify whether a horizontal speed of the UE is within a defined range, where the estimation of the current position of the UE is further based on the horizontal speed of the UE being within the defined range, such as described in connection with FIGS. 8 and 9. For example, as discussed in connection with 912 of FIG. 9, the UE 802 (or the PE of the UE 802) may be configured to check whether the horizontal speed of the UE 802 is within a defined range, such between zero (0) (e.g., miles/kilometers per hour) and a threshold value (e.g., e.g., 5, 10 miles/kilometers per hour, etc.). The identification of whether the horizontal speed of the UE is within a defined range may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, the UE may identify whether there is an EPI, where the estimation of the current position of the UE is further based on there being no EPI, such as described in connection with FIGS. 8 and 9. For example, as discussed in connection with 914 of FIG. 9, the UE 802 (or the PE of the UE 802) may be configured to check whether there is any EPI injection (e.g., from the AP). If there is no EPI injection, the UE 802 may proceed to the next process/step (e.g., to 916). The identification of whether there is an EPI may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, the UE may identify whether the prior position fix information includes a previous location and time of the UE, where the estimation of the current position of the UE is further based on the previous location and time of the UE being deleted.

In another example, the UE may estimate a steering of the UE based on at least one of elevation of a set of satellites associated with the prior GNSS positioning session or azimuth of the set of satellites associated with the prior GNSS positioning session from the prior position fix information, where the estimation of the current position of the UE is further based on the estimated steering of the UE, such as described in connection with FIGS. 8 and 9. For example, as discussed in connection with 920 of FIG. 9, the PE of the UE 802 may also be configured to send an acquisition assistance to the ME of the UE 802 and request the ME to perform checks on SVs (e.g., checking whether there are available SVs). Upon or after receiving the request from the PE, the ME may be configured to estimate the SV steering based on the prior/last position fix (e.g., based on the elevation and/or azimuth information of SV(s) associated with the prior GNSS-based positioning session). The estimation of the steering of the UE may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, the UE may identify whether a number of satellites tracked is less than four, and generate, based on the number of satellites tracked being less than four, a list of satellites by performing a time transfer from at least one satellite in the number of satellites to the list of satellites, where the estimation of the current position of the UE is further based on the list of satellites, such as described in connection with FIGS. 8 and 9. For example, as discussed in connection with 922 of FIG. 9, the ME of the UE 802 may also be configured to check whether the number of SVs tracked with SV milliseconds decode is less than four (e.g., the number of available satellites for receiving GNSS signals is less than four). As shown at 924, if the number of SVs tracked with SV milliseconds decode is less than four, the UE 802 (or the ME of the UE 802) may be configured to perform a time transfer that calculates/estimates the time/trajectories for a list of SVs based on the SV(s) with millisecond (ms) decoded (e.g., obtained at 922), and the ME may send this list of SVs to the PE. The identification of whether the number of satellites tracked is less than four and/or the generation of the list of satellites may be performed by, e.g., the fast acquisition component 198, the SPS module 1216, the transceiver(s) 1222, the cellular baseband processor(s) 1224, and/or the application processor(s) 1206 of the apparatus 1204 in FIG. 12. In some implementations, to identify whether the number of satellites tracked is less than four, the UE may be configured to identify whether the number of satellites tracked with millisecond decode is less than four.

In another example, the UE may receive an indication to initiate the current GNSS positioning session, and initiate, based on the indication, the current GNSS positioning session prior to the detection that the UE is operating in the specified GNSS environment.

In another example, the UE may compute the current position of the UE based on a set of available satellites and without using the prior position fix information if there is at least one of: a horizontal speed of the UE is above a speed threshold, at least one external position injection (EPI) is available, a previous location and time of the UE is available, or at least four satellites are available for GNSS-based positioning.

In another example, the UE may output an indication of the estimated current position of the UE. In some implementations, to output the indication of the estimated current position of the UE, the UE may be configured to transmit the indication of the estimated current position of the UE, or store the indication of the estimated current position of the UE.

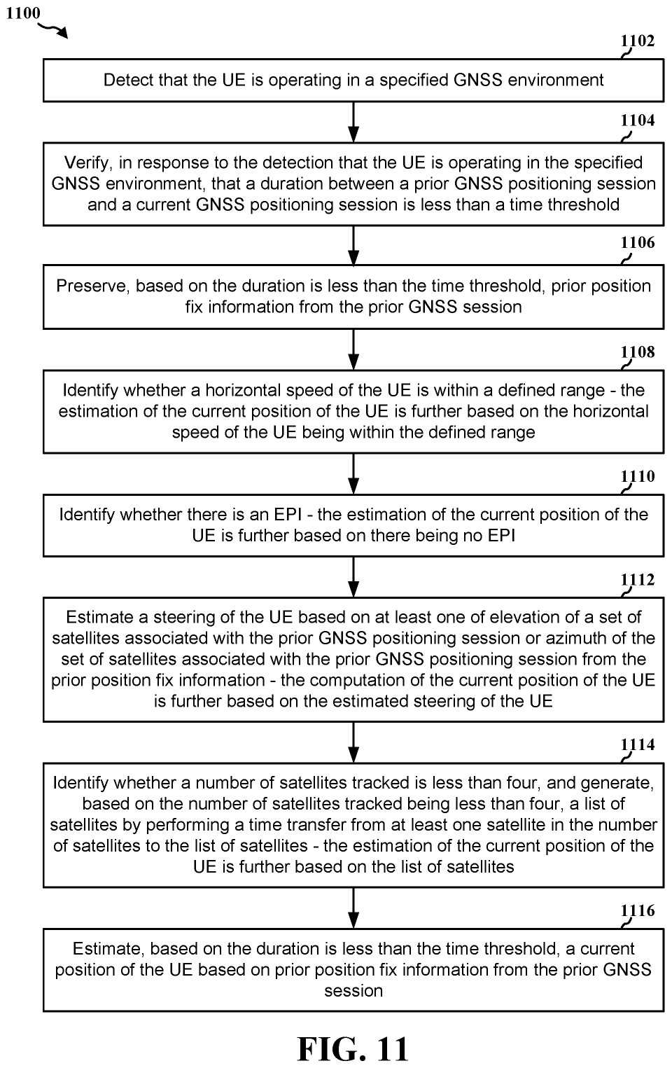

FIG. 11 is a flowchart 1100 of location estimation at a user equipment (UE). The method may be performed by a UE (e.g., the UE 104, 404, 506, 702, 802; the apparatus 1204). The method may enable the UE to achieve a faster acquisition of its estimated location in an environment with limited satellite access or SV visibilities (e.g., the UE is surrounded by canyons, mountains, trees, etc.).

At 1102, the UE may detect that the UE is operating in a specified GNSS environment, such as described in connection with FIGS. 8 and 9. For example, as discussed in connection with 902 of FIG. 9, after the GNSS-based positioning session starts or is initiated, the UE 802 may detect or verify whether UE 802 is in a defined/specified GNSS environment, such as within a GNSS challenged environment where there is a limited SV visibility (e.g., the UE 802 is unable to receive/decode GNSS signals and/or unable to receive/decode GNSS signals with signal strength above a threshold from at least four satellites). The detection of the UE being operating in a specified GNSS environment may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, to detect that the UE is operating in the specified GNSS environment, the UE may be configured to detect at least one of: receptions of GNSS signals from a set of satellites being below a reception threshold, or a number of satellites available for GNSS-based positioning being less than four.

At 1104, the UE may verify, in response to the detection that the UE is operating in the specified GNSS environment, that a duration between a prior GNSS positioning session and a current GNSS positioning session is less than a time threshold, such as described in connection with FIGS. 8 and 9. For example, as discussed in connection with 906 of FIG. 9, if the UE 802 detects that it is in a defined/specified GNSS environment, the UE 802 (or the PE of the UE 802) may be configured to check if the duration (N) between a prior GNSS-based positioning session and the current GNSS-based positioning session is less than a threshold duration (e.g., a configurable value such as 15 seconds, 30 seconds, 1 minute, etc.). The verification of the duration may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

At 1106, the UE may preserve, based on the duration is less than the time threshold, prior position fix information from the prior GNSS session, such as described in connection with FIGS. 8 and 9. For example, as discussed in connection with 910 of FIG. 9, if the duration (N) between the prior GNSS-based positioning session and the current GNSS-based positioning session is less than the threshold duration (e.g., N<threshold duration), the UE 802 may be configured to start the FACE algorithm 804. After the FACE algorithm 804 starts, the UE 802 (or the PE of the UE 802) may be configured to preserve the last/previous (best or most suitable) position fix information/details from the prior GNSS-based positioning session. The preservation of the prior position fix information from the prior GNSS session may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, the prior position fix information may include at least one of: a previous location of the UE, a previous velocity of the UE, a time in which the prior position fix information is obtained, elevation of a set of satellites associated with the prior GNSS positioning session, or azimuth of the set of satellites associated with the prior GNSS positioning session.

At 1116, the UE may estimate a current position of the UE based on the prior position fix information, such as described in connection with FIGS. 8 and 9. For example, as discussed in connection with 926 of FIG. 9, after the PE obtains the list of SVs from the ME and also the SV steering information (e.g., if available at 920), the UE 802 (or the PE of the UE 802) may compute/estimate the position of the UE 802 using the new HEPE (e.g., computed at 918), the list of SVs (e.g., obtained at 924), and/or the SV steering information (e.g., if available at 920). The estimation of the current position of the UE may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In one example, to estimate the current position of the UE based on the prior position fix information, the UE may be configured to multiply a previous velocity of the UE with the duration to obtain an estimated distance, where the previous velocity of the UE is from the prior position fix information, compute a HEPE based on the estimated distance, and compute the current position of the UE based on the computed HEPE.

In another example, as shown at 1108, the UE may identify whether a horizontal speed of the UE is within a defined range, where the estimation of the current position of the UE is further based on the horizontal speed of the UE being within the defined range, such as described in connection with FIGS. 8 and 9. For example, as discussed in connection with 912 of FIG. 9, the UE 802 (or the PE of the UE 802) may be configured to check whether the horizontal speed of the UE 802 is within a defined range, such between zero (0) (e.g., miles/kilometers per hour) and a threshold value (e.g., e.g., 5, 10 miles/kilometers per hour, etc.). The identification of whether the horizontal speed of the UE is within a defined range may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, as shown at 1110, the UE may identify whether there is an EPI, where the estimation of the current position of the UE is further based on there being no EPI, such as described in connection with FIGS. 8 and 9. For example, as discussed in connection with 914 of FIG. 9, the UE 802 (or the PE of the UE 802) may be configured to check whether there is any EPI injection (e.g., from the AP). If there is no EPI injection, the UE 802 may proceed to the next process/step (e.g., to 916). The identification of whether there is an EPI may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, the UE may identify whether the prior position fix information includes a previous location and time of the UE, where the estimation of the current position of the UE is further based on the previous location and time of the UE being deleted.

In another example, as shown at 1112, the UE may estimate a steering of the UE based on at least one of elevation of a set of satellites associated with the prior GNSS positioning session or azimuth of the set of satellites associated with the prior GNSS positioning session from the prior position fix information, where the estimation of the current position of the UE is further based on the estimated steering of the UE, such as described in connection with FIGS. 8 and 9. For example, as discussed in connection with 920 of FIG. 9, the PE of the UE 802 may also be configured to send an acquisition assistance to the ME of the UE 802 and request the ME to perform checks on SVs (e.g., checking whether there are available SVs). Upon or after receiving the request from the PE, the ME may be configured to estimate the SV steering based on the prior/last position fix (e.g., based on the elevation and/or azimuth information of SV(s) associated with the prior GNSS-based positioning session). The estimation of the steering of the UE may be performed by, e.g., the fast acquisition component 198, the SPS module 1216, the transceiver(s) 1222, the cellular baseband processor(s) 1224, and/or the application processor(s) 1206 of the apparatus 1204 in FIG. 12.

In another example, as shown at 1114, the UE may identify whether a number of satellites tracked is less than four, and generate, based on the number of satellites tracked being less than four, a list of satellites by performing a time transfer from at least one satellite in the number of satellites to the list of satellites, where the estimation of the current position of the UE is further based on the list of satellites, such as described in connection with FIGS. 8 and 9. For example, as discussed in connection with 922 of FIG. 9, the ME of the UE 802 may also be configured to check whether the number of SVs tracked with SV milliseconds decode is less than four (e.g., the number of available satellites for receiving GNSS signals is less than four). As shown at 924, if the number of SVs tracked with SV milliseconds decode is less than four, the UE 802 (or the ME of the UE 802) may be configured to perform a time transfer that calculates/estimates the time/trajectories for a list of SVs based on the SV(s) with millisecond (ms) decoded (e.g., obtained at 922), and the ME may send this list of SVs to the PE. The identification of whether the number of satellites tracked is less than four and/or the generation of the list of satellites may be performed by, e.g., the fast acquisition component 198, the SPS module 1216, the transceiver(s) 1222, the cellular baseband processor(s) 1224, and/or the application processor(s) 1206 of the apparatus 1204 in FIG. 12. In some implementations, to identify whether the number of satellites tracked is less than four, the UE may be configured to identify whether the number of satellites tracked with millisecond decode is less than four.

In another example, the UE may receive an indication to initiate the current GNSS positioning session, and initiate, based on the indication, the current GNSS positioning session prior to the detection that the UE is operating in the specified GNSS environment.

In another example, the UE may compute the current position of the UE based on a set of available satellites and without using the prior position fix information if there is at least one of: a horizontal speed of the UE is above a speed threshold, at least one external position injection (EPI) is available, a previous location and time of the UE is available, or at least four satellites are available for GNSS-based positioning.

In another example, the UE may output an indication of the estimated current position of the UE. In some implementations, to output the indication of the estimated current position of the UE, the UE may be configured to transmit the indication of the estimated current position of the UE, or store the indication of the estimated current position of the UE.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an ultrawide band (UWB) module 1238 (e.g., a UWB transceiver), an SPS module 1216 (e.g., GNSS module), one or more sensors 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the UWB module 1238, the WLAN module 1212, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the fast acquisition component 198 may be configured to detect that the apparatus 1204 is operating in a specified GNSS environment. The fast acquisition component 198 may also be configured to verify, in response to the detection that the apparatus 1204 is operating in the specified GNSS environment, that a duration between a prior GNSS positioning session and a current GNSS positioning session is less than a time threshold. The fast acquisition component 198 may also be configured to estimate, based on the duration is less than the time threshold, a current position of the UE based on prior position fix information from the prior GNSS session. The fast acquisition component 198 may be within the cellular baseband processor(s) 1224, the application processor(s) 1206, or both the cellular baseband processor(s) 1224 and the application processor(s) 1206. The fast acquisition component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for detecting that the apparatus 1204 is operating in a specified GNSS environment. The apparatus 1204 may further include means for verifying, in response to the detection that the apparatus 1204 is operating in the specified GNSS environment, that a duration between a prior GNSS positioning session and a current GNSS positioning session is less than a time threshold. The apparatus 1204 may further include means for estimating, based on the duration is less than the time threshold, a current position of the UE based on prior position fix information from the prior GNSS session.

In one configuration, the means for detecting that the apparatus 1204 is operating in the specified GNSS environment may include configuring the apparatus 1204 to detect at least one of: receptions of GNSS signals from a set of satellites being below a reception threshold, or a number of satellites available for GNSS-based positioning being less than four.

In another configuration, the apparatus 1204 may further include means for preserving, based on the duration is less than the time threshold, prior position fix information from the prior GNSS session.

In another configuration, the prior position fix information may include at least one of: a previous location of the apparatus 1204, a previous velocity of the apparatus 1204, a time in which the prior position fix information is obtained, elevation of a set of satellites associated with the prior GNSS positioning session, or azimuth of the set of satellites associated with the prior GNSS positioning session.

In another configuration, the means for estimating the current position of the apparatus 1204 based on the prior position fix information may include configuring the apparatus 1204 to multiply a previous velocity of the apparatus 1204 with the duration to obtain an estimated distance, where the previous velocity of the apparatus 1204 is from the prior position fix information, compute a HEPE based on the estimated distance, and compute the current position of the apparatus 1204 based on the computed HEPE.

In another configuration, the apparatus 1204 may further include means for identifying whether a horizontal speed of the apparatus 1204 is within a defined range, where the estimation of the current position of the apparatus 1204 is further based on the horizontal speed of the apparatus 1204 being within the defined range.

In another configuration, the apparatus 1204 may further include means for identifying whether there is an EPI, where the estimation of the current position of the apparatus 1204 is further based on there being no EPI.

In another configuration, the apparatus 1204 may further include means for identifying whether the prior position fix information includes a previous location and time of the apparatus 1204, where the estimation of the current position of the apparatus 1204 is further based on the previous location and time of the apparatus 1204 being deleted.

In another configuration, the apparatus 1204 may further include means for estimating a steering of the apparatus 1204 based on at least one of elevation of a set of satellites associated with the prior GNSS positioning session or azimuth of the set of satellites associated with the prior GNSS positioning session from the prior position fix information, where the estimation of the current position of the apparatus 1204 is further based on the estimated steering of the apparatus 1204.

In another configuration, the apparatus 1204 may further include means for identifying whether a number of satellites tracked is less than four, and means for generating, based on the number of satellites tracked being less than four, a list of satellites by performing a time transfer from at least one satellite in the number of satellites to the list of satellites, where the estimation of the current position of the apparatus 1204 is further based on the list of satellites. In some implementations, the means for identifying whether the number of satellites tracked is less than four may include configuring the apparatus 1204 to identify whether the number of satellites tracked with millisecond decode is less than four.

In another configuration, the apparatus 1204 may further include means for receiving an indication to initiate the current GNSS positioning session, and means for initiating, based on the indication, the current GNSS positioning session prior to the detection that the apparatus 1204 is operating in the specified GNSS environment.

In another configuration, the apparatus 1204 may further include means for computing the current position of the apparatus 1204 based on a set of available satellites and without using the prior position fix information if there is at least one of: a horizontal speed of the apparatus 1204 is above a speed threshold, at least one external position injection (EPI) is available, a previous location and time of the apparatus 1204 is available, or at least four satellites are available for GNSS-based positioning.

In another configuration, the apparatus 1204 may further include means for outputting an indication of the estimated current position of the apparatus 1204. In some implementations, the means for outputting the indication of the estimated current position of the apparatus 1204 may include configuring the apparatus 1204 to transmit the indication of the estimated current position of the apparatus 1204, or store the indication of the estimated current position of the apparatus 1204.

The means may be the fast acquisition component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: detecting that the UE is operating in a specified global navigation satellite system (GNSS) environment; verifying, in response to the detection that the UE is operating in the specified GNSS environment, that a duration between a prior GNSS positioning session and a current GNSS positioning session is less than a time threshold; and estimating, based on the duration is less than the time threshold, a current position of the UE based on prior position fix information from the prior GNSS session.
Aspect 2 is the method of aspect 1, wherein the prior position fix information includes at least one of: a previous location of the UE, a previous velocity of the UE, a time in which the prior position fix information is obtained, elevation of a set of satellites associated with the prior GNSS positioning session, or azimuth of the set of satellites associated with the prior GNSS positioning session.
Aspect 3 is the method of aspect 1 or aspect 2, further comprising: identifying whether a horizontal speed of the UE is within a defined range, wherein the estimation of the current position of the UE is further based on the horizontal speed of the UE being within the defined range.
Aspect 4 is the method of any of aspects 1 to 3, further comprising: identifying whether there is an external position injection (EPI), wherein the estimation of the current position of the UE is further based on there being no EPI.
Aspect 5 is the method of any of aspects 1 to 4, further comprising: identifying whether the prior position fix information includes a previous location and time of the UE, wherein the estimation of the current position of the UE is further based on the previous location and time of the UE being deleted.
Aspect 6 is the method of any of aspects 1 to 5, wherein estimating the current position of the UE based on the prior position fix information comprises: multiplying a previous velocity of the UE with the duration to obtain an estimated distance, wherein the previous velocity of the UE is from the prior position fix information; computing a horizontal error position estimate (HEPE) based on the estimated distance; and computing the current position of the UE based on the computed HEPE.
Aspect 7 is the method of any of aspects 1 to 6, further comprising: estimating a steering of the UE based on at least one of elevation of a set of satellites associated with the prior GNSS positioning session or azimuth of the set of satellites associated with the prior GNSS positioning session from the prior position fix information, wherein the estimation of the current position of the UE is further based on the estimated steering of the UE.
Aspect 8 is the method of any of aspects 1 to 7, further comprising: identifying whether a number of satellites tracked is less than four; and generating, based on the number of satellites tracked being less than four, a list of satellites by performing a time transfer from at least one satellite in the number of satellites to the list of satellites, wherein the estimation of the current position of the UE is further based on the list of satellites.
Aspect 9 is the method of any of aspects 1 to 8, wherein identify whether the number of satellites tracked is less than four comprises: identifying whether the number of satellites tracked with millisecond decode is less than four.
Aspect 10 is the method of any of aspects 1 to 9, further comprising: receiving an indication to initiate the current GNSS positioning session; and initiating, based on the indication, the current GNSS positioning session prior to the detection that the UE is operating in the specified GNSS environment.
Aspect 11 is the method of any of aspects 1 to 10, further comprising: computing the current position of the UE based on a set of available satellites and without using the prior position fix information if there is at least one of: a horizontal speed of the UE is above a speed threshold, at least one external position injection (EPI) is available, a previous location and time of the UE is available, or at least four satellites are available for GNSS-based positioning.
Aspect 12 is the method of any of aspects 1 to 11, wherein detecting that the UE is operating in the specified GNSS environment comprises: detecting at least one of: receptions of GNSS signals from a set of satellites being below a reception threshold, or a number of satellites available for GNSS-based positioning being less than four.
Aspect 13 is the method of any of aspects 1 to 12, further comprising: outputting an indication of the estimated current position of the UE.
Aspect 14 is the method of aspect 13, wherein outputting the indication of the estimated current position of the UE comprises: transmitting the indication of the estimated current position of the UE; or storing the indication of the estimated current position of the UE.
Aspect 15 is the method of any of aspects 1 to 14, further comprising: preserving, based on the duration is less than the time threshold, prior position fix information from the prior GNSS session.
Aspect 16 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 15.
Aspect 17 is the apparatus of aspect 16, further including at least one transceiver coupled to the at least one processor.
Aspect 18 is an apparatus for wireless communication at a user equipment (UE) including means for implementing any of aspects 1 to 15.
Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a user equipment (UE), comprising:
at least one memory; and
at least one processor coupled to the at least one memory, the at least one processor, individually or in any combination, is configured to:
detect that the UE is operating in a specified global navigation satellite system (GNSS) environment;
verify, in response to the detection that the UE is operating in the specified GNSS environment, that a duration between a prior GNSS positioning session and a current GNSS positioning session is less than a time threshold; and
estimate, based on the duration is less than the time threshold, a current position of the UE based on prior position fix information from the prior GNSS session.

2. The apparatus of claim 1, wherein the prior position fix information includes at least one of:
a previous location of the UE,
a previous velocity of the UE,
a time in which the prior position fix information is obtained,
elevation of a set of satellites associated with the prior GNSS positioning session, or
azimuth of the set of satellites associated with the prior GNSS positioning session.

3. The apparatus of claim 1, wherein the at least one processor, individually or in any combination, is further configured to:
identify whether a horizontal speed of the UE is within a defined range, wherein the estimation of the current position of the UE is further based on the horizontal speed of the UE being within the defined range.

4. The apparatus of claim 1, wherein the at least one processor, individually or in any combination, is further configured to:
identify whether there is an external position injection (EPI), wherein the estimation of the current position of the UE is further based on there being no EPI.

5. The apparatus of claim 1, wherein the at least one processor, individually or in any combination, is further configured to:
identify whether the prior position fix information includes a previous location and time of the UE, wherein the estimation of the current position of the UE is further based on the previous location and time of the UE being deleted.

6. The apparatus of claim 1, wherein to estimate the current position of the UE based on the prior position fix information, the at least one processor, individually or in any combination, is configured to:
multiply a previous velocity of the UE with the duration to obtain an estimated distance, wherein the previous velocity of the UE is from the prior position fix information;
compute a horizontal error position estimate (HEPE) based on the estimated distance; and
compute the current position of the UE based on the computed HEPE.

7. The apparatus of claim 1, wherein the at least one processor, individually or in any combination, is further configured to:
estimate a steering of the UE based on at least one of elevation of a set of satellites associated with the prior GNSS positioning session or azimuth of the set of satellites associated with the prior GNSS positioning session from the prior position fix information, wherein the estimation of the current position of the UE is further based on the estimated steering of the UE.

8. The apparatus of claim 1, wherein the at least one processor, individually or in any combination, is further configured to:
identify whether a number of satellites tracked is less than four; and
generate, based on the number of satellites tracked being less than four, a list of satellites by performing a time transfer from at least one satellite in the number of satellites to the list of satellites, wherein the estimation of the current position of the UE is further based on the list of satellites.

9. The apparatus of claim 8, wherein to identify whether the number of satellites tracked is less than four, the at least one processor, individually or in any combination, is configured to:
identify whether the number of satellites tracked with millisecond decode is less than four.

10. The apparatus of claim 1, wherein the at least one processor, individually or in any combination, is further configured to:
receive an indication to initiate the current GNSS positioning session; and
initiate, based on the indication, the current GNSS positioning session prior to the detection that the UE is operating in the specified GNSS environment.

11. The apparatus of claim 1, wherein the at least one processor, individually or in any combination, is further configured to:
compute the current position of the UE based on a set of available satellites and without using the prior position fix information if there is at least one of:
a horizontal speed of the UE is above a speed threshold,
at least one external position injection (EPI) is available,
a previous location and time of the UE is available, or
at least four satellites are available for GNSS-based positioning.

12. The apparatus of claim 1, wherein to detect that the UE is operating in the specified GNSS environment, the at least one processor, individually or in any combination, is configured to:
detect at least one of:
receptions of GNSS signals from a set of satellites being below a reception threshold, or
a number of satellites available for GNSS-based positioning being less than four.

13. The apparatus of claim 1, wherein the at least one processor, individually or in any combination, is further configured to:
output an indication of the estimated current position of the UE.

14. The apparatus of claim 13, wherein to output the indication of the estimated current position of the UE, the at least one processor, individually or in any combination, is configured to:
transmit the indication of the estimated current position of the UE; or
store the indication of the estimated current position of the UE.

15. The apparatus of claim 14, further including at least one transceiver coupled to the at least one processor, wherein to transmit the indication, the at least one processor, individually or in any combination, is configured to transmit the indication via the at least one transceiver.

16. The apparatus of claim 1, wherein the at least one processor, individually or in any combination, is further configured to:
estimate, based on the duration is less than the time threshold, a current position of the UE based on prior position fix information from the prior GNSS session.

17. A method of wireless communication at a user equipment (UE), comprising:
detecting that the UE is operating in a specified global navigation satellite system (GNSS) environment;
verifying, in response to the detection that the UE is operating in the specified GNSS environment, that a duration between a prior GNSS positioning session and a current GNSS positioning session is less than a time threshold;
preserving, based on the duration is less than the time threshold, prior position fix information from the prior GNSS session; and
estimating a current position of the UE based on the prior position fix information.

18. The method of claim 17, wherein the prior position fix information includes at least one of:
a previous location of the UE,
a previous velocity of the UE,
a time in which the prior position fix information is obtained,
elevation of a set of satellites associated with the prior GNSS positioning session, or
azimuth of the set of satellites associated with the prior GNSS positioning session.

19. The method of claim 17, further comprising:
identifying whether a horizontal speed of the UE is within a defined range, wherein the estimation of the current position of the UE is further based on the horizontal speed of the UE being within the defined range; and
identifying whether there is an external position injection (EPI), wherein the estimation of the current position of the UE is further based on there being no EPI.

20. A computer-readable medium storing computer executable code, the code when executed by at least one processor causes the at least one processor to:
detect that a user equipment (UE) is operating in a specified global navigation satellite system (GNSS) environment;
verify, in response to the detection that the UE is operating in the specified GNSS environment, that a duration between a prior GNSS positioning session and a current GNSS positioning session is less than a time threshold; and
estimate, based on the duration is less than the time threshold, a current position of the UE based on prior position fix information from the prior GNSS session.
